(19) United States
(12) Patent Application Publication
(10) Pub. No.: US 2003/0105709 A1
(43) Pub. Date: Jun. 5, 2003

(54) Internet auction site with immediate payment processsing

(76) Inventor: Edward Orlando, Bethlehem, PA (US)

Correspondence Address: JoAnne M. Denison, Denison & Assocs, PC, Suite 1608, 212 W. Washington St., Chicago, IL, 60606-3487, US

(21) Appl. No.: 10/011,600

(22) Filed: Dec. 3, 2001

(51) Int. Cl. G06F 17/60

(52) U.S. Cl. 705/39

(57) ABSTRACT

The present invention consists of an improved method for internet or on-line auction websites wherein the winning bidder may automatically pay for her or his purchase by simply clicking on a screen after being informed that they have won the auction and the merchandise is paid for in one of many methods or options which have been heretofore selected and set up by the website auction operator as being preferred by its user. For example, after being informed that the winner has won a particular option, the user can simply select from a set of choices, pay by credit card, pay by check by e-mail, pay by automatic debit from a checking account, etc. and the goods are automatically shipped. At the time the user joins the auction website, all information with respect to credit cards and checking account information is input by the user once and only once, together with preferred shipping information and addresses so that the user only sees and uses one screen instead of 4 or 5 to complete a transaction. Further, where it used to take 3 to 5 days to exchange information and have the user send a check and the seller receive the check prior to shipping, now payment can be received/processed and the goods shipped in 24 hours.

### FIELD OF THE INVENTION

The present invention relates to the field of internet or on-line auction bidding and automatic payment systems. In particular it relates to processes which avoid the step of negotiating checks and money orders through the postal system in order to receive goods in the fastest possible manner after either making a purchase or receiving the highest, winning bid.

### BACKGROUND OF THE INVENTION

Currently, in the marketplace, there are available a wide variety of automatic on-line payment systems wherein after a shopper has loaded up an electronic shopping cart, the shopper can click on a button with a mouse and go to electronic checkout wherein the computer requests credit card and shipping information, and then after qualification, the goods are shipped to the consumer. Sometimes the shopper's shipping information is retained in the user's account so that this information does not have to be reentered. But typically, most all companies require fresh credit card information be entered by the shopper.

There are also internet payment systems wherein if a seller does not take credit cards due to the cost or inconvenience in obtaining a merchant account, the seller can accept a check which is generated through an internet site which accepts the credit card of the consumer and then promises in turn to pay the seller by check by mail within a few days. In this system, after a user wins a bid, he or she must then visit this site and enter the necessary information, which is an additional time consuming step. This is not currently done directly at the internet auction site, so that the user will have to select and create a separate account with possibly different information at the internet payment site. However, there is no simple and quick method by which a winning bidder can automatically have a credit card debited, or a pre-paid account debited, so that merchandise can be shipped immediately and the seller can ship immediately and be guaranteed payment.

U.S. Pat. No. 5,732,400 issued to Mandler discloses a process for enabling online transaction service among unrelated buyers and sellers. It serves as a financial clearinghouse for receiving a request or goods or services from a buyer and making a real-time determination of risk classification of the buyer utilizing on-line credit information to determine a risk-based discount fee. If the transaction is authorized by the financial clearinghouse, the payment will be transmitted to the seller. However in the Mandler system, automatic payment by the purchaser is not at all involved.

In another patent issued to Walker U.S. Pat. No. 5,794,207 is disclosed a method and apparatus for effectualizing buyer-driven sales of goods. In this system, commonly known in the relevant marketplace as “priceline.com”, an offeror makes a bit on the sale of goods or services and this bid is presented to a myriad of sellers of known quantities of goods, such as airline tickets. However, with this system, before an item is offered as needed by a buyer for the price the buyer is willing to pay, the buy must insert credit card information and a hold for that amount is place on the credit card holder's account, regardless of whether the transaction is completed. The obvious problem with such a situation is that whenever the credit card holder's account is placed on hold for a certain amount, the seller is charged a fee when the card is placed on hold, and then again when the transaction is completed and the parties agree, all of which leads to double the normal charge for a credit card transaction, which fees can be extremely significant. Accordingly, there are significant drawbacks to such a system. Moreover, this system is not adaptable to on-line or internet auctions.

In the Godlin patent, U.S. Pat. No. 5,890,138 is disclosed a different method and system for providing rapid feedback of a reverse auction process wherein a fairly complicated method is used to sell a large quantity of a given item in lots for optimal prices in the shortest amount of time. In this particular type of auction the participants are preregistered and they then contact financial institutes so that automatic payment confirmation is carried out. In this system, however, the user can opt out of when he wishes to purchase an item at a particular price and then either credit cord information is utilized which the user inputs after receiving an e-mail confirming he has purchased an item, or the user can put in credit card information into his account ahead of time. In either case, the payment is not triggered until the user has actually made a sale and payment is then requested. The payment is not made automatically the end of the auction by the high bidder.

In yet another patent issued to Brett, U.S. Pat. No. 6,023,685 is disclosed a fairly complicated ticket auction system which evaluates and receives bid information from users on the internet. The user can see a virtual seating area and can input desired blocks of seats together, as a ticket agent can, and the user can also see current bidding prices according to a graphical area on the screen in order to assess and make a bid on a number of seats. However, in this system, in order to gain access, a credit card hold for a given amount must be placed by the user in order to gain access to the system, and then the card is actually charged when a bid is won by the user, resulting in double the normal credit card processing fees. As such, it is not very desirable. At the very least, after a winning bid is won, an e-mail is sent and the user must then input credit card information some time later before tickets are shipped.

There is also currently no system wherein if the winning bidder does not have a working credit card or sufficient funds on his or her account, that the internet auction site will automatically skip to the next highest bidder and immediately declare that bidder as the winner. Nor is there a centralized payment system which is take and automatically processed by a plurality of merchants. Nor is there a centralized payment system which can create a virtual major credit card for a buyer who does not have one or who does not desire to disclose sensitive credit card information on line. Currently, the seller always takes the risk that someone will win an auction and will not either send the seller credit card information, if the seller takes credit cards, which many do not, nor is the seller guaranteed that the winner of the bid will actually send the check or money order or that a check will be good. Oftentimes, a seller is stuck waiting and hoping that valid payment will arrive, before he or she can ship merchandise. Then, much to the seller's dismay, if payment is not received, the seller must begin the auction process anew, greatly delaying the whole process of selling the merchandise. As a result, the current auction payment systems are extremely cumbersome and inefficient which presents numerous impediments to both sellers and buyers alike.

### SUMMARY OF THE INVENTION

The present invention consists of an improved method for internet or on-line auction houses wherein after a bidder has won an auction by being the highest bidder according to a preselected period of time, generally about 5 to 7 days, at the end of the auction, the internet auction site automatically scans the bidder's account for a predeposit of check or money order, or a credit card is automatically debited for the amount of the bid, based upon the prior selection of the bidder. Currently, when a bidder has won an auction by being the highest bidder at the end of the auction, both parties, seller and high bidder contact one another by e-mail regarding transmission of payment through the mail. The parties often discuss whether or not certain credit cards will be taken, if at all, and whether or not personal checks will be taken. Frequently, with unknown purchasers, the seller will want a money order and will not accept personal checks. This requires yet and additional step of the buyer taking a trip to the Post Office or another place which sells money orders. Not all bidders have credit cards for immediate shipment of the goods. Not all sellers have the ability to take credit cards, because credit card processing equipment is very expensive and there is a long involved process to set up the credit card processing system for the merchant, which involves references and credit checks, which not all sellers qualify for. There are also substantial monthly fees and statement fees, as well as transaction fees, which must be paid whether the system is in use or not. As a result, because most parties offering merchandise on an internet auction site are not professionals with established businesses, but are only individuals offering extra or special merchandise, many internet auction sellers do not take credit cards at all.

The payment, therefore, is typically a check or a money order and it is sent by snail mail to the seller. In the case of a check, it is typically held upon receipt an additional 5 to 7 days to make certain that the funds have been transferred without problem. Sometimes sellers ship immediately and the check is returned “insufficent funds” or “account closed”. As a result, the current internet auction payment system is unduly cumbersome and slow and requires superfluous communication between seller and buyer of internet auction merchandise.

The present invention anticipates each individual user of the auction site signing up for a personal account wherein the user, if he or she does not have a credit card, may prepay by check or money order a certain amount into his or her account, so that funds will be available if and when an auction bid succeeds. Accordingly, a user can create a virtual check for pre-deposit of funds by entering in ABA routing number and account number and check number to have the funds immediately transferred from the user's bank. Or, in the alternative, when an auction is won, the user's credit card may be automatically debited for the amount so that the seller can ship the merchandise immediately. As another possible alternative, the seller can elect to have an electronic check generated and sent after the auction is terminated based upon checking account information previously submitted by the user kept in the user's account.

On the seller's end, the seller will be able to select from a wide array of payment receipt methods, including processing a credit card directly into an established merchant account which will flow through in the usual manner into the seller's business checking account through the seller's credit card processor, (which would involve only the seller's normal credit card fees), or the payment can be made by check to the seller, in which event the check will be guaranteed to ship the next business day and the seller can expect receipt in 5 to 7 days through the US Postal Service. Or, in the alternative, the seller can set up direct electronic check payment into a checking account which the seller has already input data such as the ABA routing number and account number. It is anticipated with this electronic system that there will be a small charge to the seller, and the payment transfer would be guaranteed to reach the seller's bank account in 2 to 3 business day.

Hence, after a user has placed a bid, and upon expiry of the auction, payments are automatically transferred and e-mail is sent to the seller to immediately ship the merchandise. As a result, the entire process has decreased from a time frame of 7 to 14 days down to only a few days because payment by the buyer and shipment by the seller is substantially immediate. It is expected therefore, that merchandise will be received in 3 to 7 days, at most, even after allowing a day to two to ship.

It is further anticipated that this automatic payment portion of the present invention may be adopted to be used as a central clearing house for payments from a variety of merchants and sellers. Currently, when a purchaser has bought goods on the internet, they “checkout” their shopping cart and enter shipping information and credit card information, which is a fairly tedious process involving a number of screens and an additional 5 to 10 minute wait to complete the purchase of goods on the internet. However, with the present system, a purchaser can simply checkout by requesting central checkout and entering in a proprietary password and user ID which can be changed at the central internet payment center. In such a manner, this ID and proprietary password can be used at a wide variety of internet retailers and it allows the shopper to checkout with a minimum of trouble and the shopper does not have to disclose actual credit card information or even an address on line and in such a manner the shopper can feel far more secure. Merchants can simply list various internet payment center names and take an id and password in lieu of the standard 4 credit card commonly accepted, namely, American Express, MasterCard, VISA and Discover. Or, the internet payment center can merely mimic an existing credit card, such as VISA, so that payment can be authorized through the internet payment center with a “virtual VISA” or other name brand credit card, even though a completely different credit card is being used, or an account balance was created at the internet payment center with a check or money order.

It is only a simple matter for the merchant, with proper secure, encrypted authorization, to log into the internet payment center and request the information directly and securely regarding preferred credit card, or a debit from the balance on the shopper's account which was already submitted by money order or check or virtual check, and the shipping information. Currently, internet payment centers do exist, but the shopper must log into the site separately and enter in credit card or account information and pass a number of screens to complete the purchase desired. They are not geared toward saving time at all.

### OBJECTS OF THE INVENTION

Thus it is a primary object of the present invention to greatly simplify the process of engaging in internet auctions wherein after an internet auction ends, payment can be automatically processed, and the goods purchased may be substantially immediately sent to the purchaser.

It is yet another primary object of the present invention to provide an internet auction site with automatic payment processing wherein the user provides payment information when the auction account is established so that it need not be provided at the end of each individual auction that the user has won.

It is another primary object of the present invention to provide an internet auction site with automatic payment processing wherein the user con enter in shipping information at the time the auction account is established so that it need not be provided at the end of each individual auction that the user has won.

It is still another primary object of the present invention to provide an internet auction site which processes payment automatically and directly to the seller, so that payment can be made by credit card on behalf of the buyer who does not have a credit card by the auction site and the buyer need not access another site to do this after the auction has ended.

It is still yet a primary object of the present invention to provide a central internet payment processing system wherein a user can set up an account with the internet payment processing system which can be used on a variety of shopping web sites to automatically pay for and ship goods after the user has either left the site or has checked out.

It is another primary object of the present invention to provide a central internet payment processing system wherein a user can set up an account with the internet payment processing system wherein a user can obtain and use a virtual credit card having 15 or 16 digits similar to a major credit card so that the user need not either use actual sensitive credit card information at a variety of internet shopping sites, which may be intercepted and wrongfully used.

It is still another primary object of the present invention to provide a central internet payment processing system wherein a user can set up an account and use a virtual credit card and this virtual credit card will be compared with the billing and shipping address(es) authorized on file with the internet payment processing system to prevent credit card fraud.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 shows one preferred embodiment of the present invention utilizing automatic payment at the end of an auction.

FIG. 2 shows an alternative embodiment of the present invention utilizing automatic payment through a centralized internet payment center.

FIG. 3 shows a flow chart of the system by which merchants can access and download information from an internet central payment processing center to obtain immediate payment for goods ordered online.

### DETAILED DESCRIPTION OF THE DRAWINGS

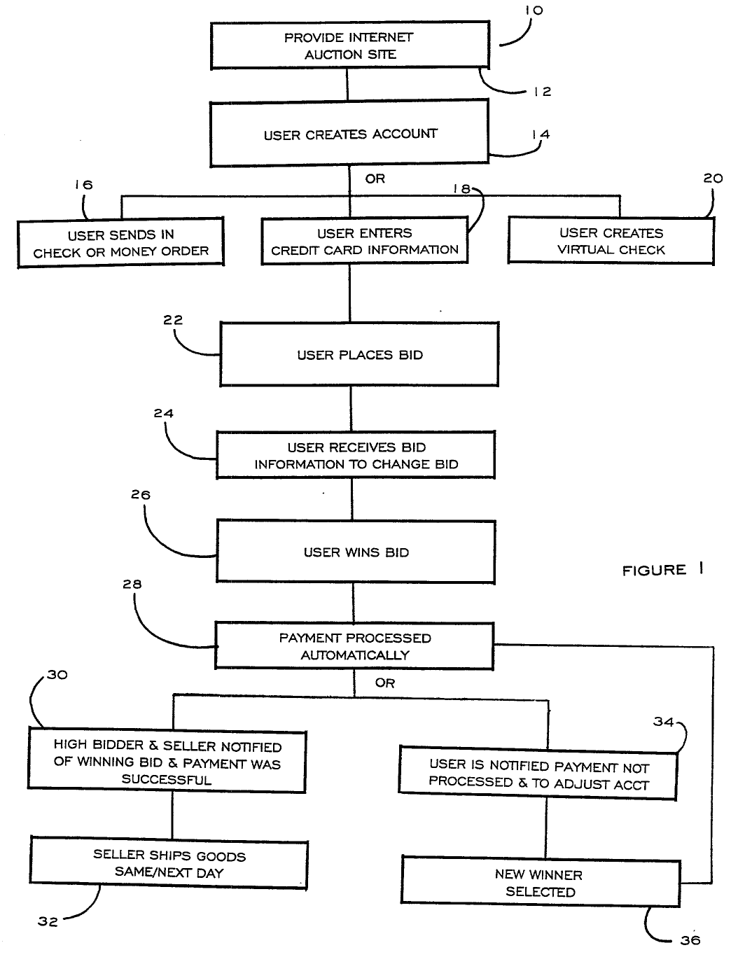

Shown in FIG. 1 is an internet auction site with automatic payment processing 10 in which a user, upon completing an auction as the winning bid, can have payment automatically processed and the goods shipped substantially immediately, generally within in 24 hours or less. With the present invention, a user can log into an internet auction web site 12, set up an account with an unique user ID and password 14, and then enter in payment information such as a credit card 16, or the user can send in a check or money order to fund the account 18, or the user can create and enter a virtual check 20 to be processed by the internet auction site by entering in the user's checking account ABA number and account number wherein a check is automatically generated by the auction site and sent to its own bank for processing. The internet auction site can also process this check information thru Tele-Check or other check processing software to determine in advance if there are any problems with the check submitted, and it is up to the internet auction site to either allow funds to be immediately available or to wait until funds are actually received from the user's bank, which should only take 1 to 2 business days.

Then, the user is able to enter into the auction web site, view the items up for bid and then place a bid on goods desired 22. As typical in most auction sites, the bidder is informed by e-mail if his bid is usurped and is given the opportunity to increase his bid 24.

But finally, at the end of the auction (and most auctions are run over a period of 2 to 10 days) a winner is determined from the high bid 26. This winning bid is then selected for payment processing automatically at the end of the auction upon selection as the winner 28. If the payment is properly processed, and either sufficient funds are available in the user's account or a credit card charge is returned with an authorization number, then both seller and buyer are notified that the auction is over and the buyer has won 30. The seller then, in accordance with a prior agreement with the internet auction site, is obligated to ship the goods won in the auction within a very short period of time, typically only 12 to 24 hours, or the next business day 32. In some instances, many professional sellers run their warehouses 24 hours per day, so there is very little time lag between winning an auction and shipment of goods.

In one preferred embodiment of the present invention, if the payment cannot be processed because the user's account had insufficient funds, or a credit card payment is declined, a notice will be sent to the user only that his funds were inadequate and/or the credit card information he or she entered was declined, so that the user can make appropriate adjustments to the user's account 34. In addition, the internet auction web site will select a new winner from the next highest bid 36 and the payment authorization process will begin anew 28. Of course, it is anticipated that in some systems, it may be advantageous to ask the seller to wait a day or so until the buyer can be offered the opportunity to submit new credit card information, because the differential between the winning bid and the next bid is so great, this may be worthwhile for the seller. These are seller options which can be made available on the system to process winning bids automatically, with the least amount of hassles and the greatest opportunity for profitability by sellers.

Of course it is anticipated that an alternative version of the present invention can be adopted to create an automated payment system which can be used by any other web site where a payment must be made for goods or services. For example, other established web action sites may wish to provide a click on button upon entering the web site where the user can elect to use a central payment processing system at the time of log in. With this method, the user will click on a button and a pull down menu will appear of one or more central automated payment system centers and the user will select one. The user will enter in an ID which may be the same or different from the central automated payment system (although the same ID is definitely preferred for economy of time), and then the user can simply enter into an auction knowing that no more information need be entered by the user.

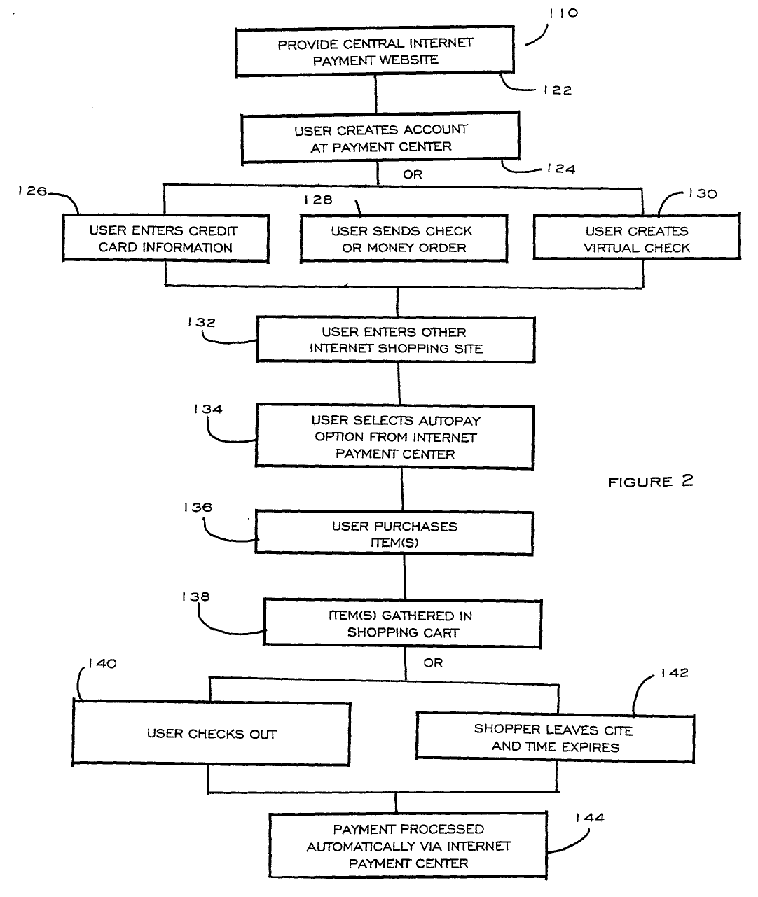

FIG. 2 shows the details of operation of one preferred embodiment of such a system wherein an internet central payment processing system 110 is shown. In such a system, the user merely enters into the internet payment processing website 122 and creates an account by entering a selected ID and password 124. The user then can chose to either enter credit card information 126, or the user can elect to send the payment processing center a check or money order 128 or the user can create a virtual check online 130 by entering in the user's ABA routing number, bank account number, and check number, if desired. As FIG. 1 indicates, in one preferred embodiment of the present invention, the user may even select and create a virtual credit card number, which will be accepted by the major (VISA, American Express, MasterCard or Discover) credit card companies. The purpose of this feature would be to provide a credit card number to persons who do not desire to disclose their actual credit card numbers to a wide variety of shopping centers on line, or they can use a credit card number even if they do not currently have one or cannot qualify for one. The user can then exit from the internet central payment processing website from a variety of web based shopping/auction centers where a payment is required to ship goods 132.

At the desired shopping cite, in one preferred embodiment of the present invention, a button or pull down menu is provided on the very first screen wherein the user can specify that payment will be processed by the internet payment processing center 134, and then all the user needs to do is enter in an ID and password for that internet payment processing center and all orders will be automatically processed at the end of shopping. The user then shops, selecting all items desired 134, and then gathers those items in a virtual shopping cart 138, and then if desired, the user will either simply leave the site or the user will actually click on a virtual check out button 140. If the user simply leaves the site 142, the ordered items will be processed for payment and shipment after a predetermined time, either after 4 hours of no activity on the site, or at the end of the day and a confirmation is sent to the user by e-mail. Or, the user can use the virtual check out button to confirm that the user will not be returning to the site and the order can be immediately processed for payment and shipment 140. With such as senario, the user has bypassed the entire tedious entry of rote payment and shipping information, which can be provided to the merchant later by the internet payment processing center, thus saving the user 5 to 10 minutes in flipping through checkout screens.

Of course if the internet shopping center does not recognize the internet payment processing center, then all the user needs to do is enter in the customary shipping information and the virtual credit card number 144, in order to guarantee the most absolute security, inasmuch as the credit card number generated by the internet payment processing center can only be used on the internet and shipping can only be made to the persons and places preauthorized by the user at the internet payment center. It is anticipated that this system will not allow goods shipped with this credit card number to go to any addresses not authorized directly to the internet payment processing center, with confirmation by e-mail to the owner of the account, thus making fraud for more difficult than with typical credit card arrangements where anyone can enter in information to where goods must be shipped.

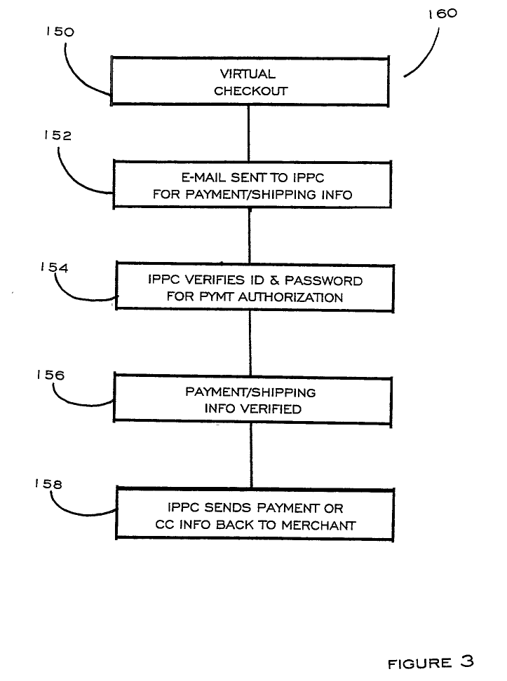

Finally, shown in FIG. 3 is the automatic payment processing system 160 by which a merchant will download information from the internet payment processing center after a virtual checkout has occured at the shopping or internet center 150. The merchant will send an encrypted e-mail or a downloadable file to the internet payment processing center to obtain shipping and payment information 152. In the merchant's communication, it will provide either the user's ID and password, which will be compared to actual records, or it will provide the virtual credit card information regarding the billing and shipping address before authorization will take place by the internet payment processing center 154. Once authorized, the process will continue. If the merchant has elected to debit credit cards itself, then it will receive the actual credit card information directly from the internet payment processing center either by secure e-mail or encrypted file. However, a variety of payment options for the merchant will exist with varying costs. It is anticipated that the funds may be electronically transferred from the internet payment processing center directly to the merchant's bank account within a very short period of time, typically 24 or 48 hours, then a small charge will apply. However, if the merchant is merely requesting a check sent from the internet payment processing center which is generated and mailed in 24 hours, then there is also no charge. In this case, the internet processing center either debits a credit card it has on file, or it will debit the user's account, for those users paying by check or money order. In any case, the internet processing center's fee is generally made from the float of money which is passing through its accounts. After authorizing payment, the user will be notified by e-mail to prevent fraud with the internet payment processing center.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. An improved internet or online auction site operated by an auction site provider incorporating a fully automated payment system comprising the following steps:
a user establishing an internet auction site account by selecting a user id;
a user funding the internet auction site;
the user placing a bid on the internet auction site for at least one item of merchandise;
the user winning a high bid on the internet auction site for at least one item of merchandise;
the internet auction site substantially immediately at the end of the auction processing payment for the item;
the seller shipping merchandise to the user substantially immediately after payment is received.

2. The internet auction system with fully automated payment according to claim 1 further comprising the step of:
the internet auction site processing payment by debiting a credit card or deducting the amount from the user's account.

3. The internet auction system with fully automated payment according to claim 2 wherein if the credit card is declined or if the user's account is insufficient to cover the cost of the transaction, then the internet auction site selecting the next highest winning bid as the winner of the auction.

4. The internet auction system with fully automated payment according to claim 1 in which the user funds the account by sending a negotiable instrument to the internet auction site provider.

5. The internet auction system with fully automated payment according to claim 1 in which the user funds the account by submitting the user's checking account information to the internet auction site provider.

6. An improved central internet payment processing system incorporating a fully automated payment system comprising the following steps:
providing a central internet payment processing website;
a user establishing an internet central payment account at the website by selecting at least a user id;
a user funding the payment account;
the user entering an internet shopping site and providing internet central payment account information at the internet shopping site;
the user purchasing at least one item of goods on the internet shopping site;
the internet shopping site obtaining payment information by sending a query to the internet central payment processing website;
the internet shopping site shipping goods to the user after payment.

7. An improved central internet payment processing system incorporating a fully automated payment system wherein the payment account is funded by providing the user's credit card information.

8. An improved central internet payment processing system incorporating a fully automated payment system wherein the payment account is funded by the user by sending the provider a negotiable instrument.

9. An improved central internet payment processing system incorporating a fully automated payment system wherein the payment account is funded by the user by submitting the user's checking account information to the payment site provider.
